(19) United States
(12) Patent Application Publication
(10) Pub. No.: US 2003/0117081 A1
(43) Pub. Date: Jun. 26, 2003

(54) Flat panel display and method

(75) Inventor: Kazuhiko Kasano, San Diego, CA (US)

Correspondence Address: Aldo J. Test, DORSEY & WHITNEY LLP, Suite 3400, Four Embarcadero Center, San Francisco, CA, 94111-4187, US

(73) Assignee: Display Research Laboratories, Inc.

(21) Appl. No.: 10/153,213

(22) Filed: May 20, 2002

Related U.S. Application Data
(60) Provisional application No. 60/343,102, filed on Dec. 21, 2001.

(51) Int. Cl. H05B 37/00

(52) U.S. Cl. 315/167; 315/169.3

(57) ABSTRACT

A flat panel display that includes a ceramic substrate, side walls and a transparent window forming an evacuated envelope is described. The substrate serves to support anode pads or a semiconductor chip having anode pads within the envelope. Electrical leads are embedded in the ceramic substrate and serve to provide electrical connection between the interior and exterior of the envelope.

### RELATED APPLICATIONS

This application claims priority to Provisional Application Serial No. 60/343,102 filed Dec. 21, 2001.

### FIELD OF THE INVENTION

This invention relates generally to a flat panel for displaying visual information, and more particularly to a flat panel display employing a multi-layer ceramic substrate and a transparent glass window in which the electrical connections between external circuits and internal circuits or elements is via wiring embedded in the ceramic substrate.

### BACKGROUND OF THE INVENTION

Vacuum Fluorescent Displays (VFDs) using glass vacuum envelopes are known. Since a VFD is essentially a triode tube having a hot filament and electron smoothing grid and anodes, the same techniques used for making electronic vacuum tubes are commonly applied to the manufacture of VFDs.

Standard VFDs are thus generally constructed with a glass substrate onto which anodes are formed or which supports one or more semiconductor chips, which contain integrated circuits and a matrix of anodes. Electrical wiring for connection to the anodes or the chips is on the surface of the glass substrate. Because of the low processing temperatures, the metal leads or wires and the anode pads do not tightly adhere to the glass. Furthermore, the internal anode pads or circuitry are connected to external circuitry via the surface leads, which extend between the sidewalls and the glass substrate. Seals where the leads extend between the side walls and of the glass substrate are difficult to make. This is a weak point of the vacuum package. Furthermore, the wires or leads comprise a single layer limiting the number of connections which can be made at the one surface.

### SUMMARY OF THE INVENTION

It is an object of the present invention to provide an improved vacuum display package having a multi-layer low temperature ceramic substrate with embedded leads or wiring for connection between elements or devices within the evacuated envelope and exterior circuits or devices.

The invention includes a vacuum envelope having a multi-layered ceramic substrate with embedded wiring providing electrical connection between elements or circuits mounted on the ceramic substrate within the envelope and exterior circuits or devices as required. A glass window is supported above and spaced from the substrate. The internal elements of the display include anodes with a phosphor layer which emit light when struck by electrons, a heated filament which supplies the electrons, and a control grid.

### BRIEF DESCRIPTION OF THE DRAWINGS

FIG. 1 is a sectional view of a flat vacuum display assembly in accordance with one embodiment of the present invention.

FIG. 2 is a perspective exploded view of the flat vacuum display of FIG. 1 showing the anode pads and connection pads carried by the base or substrate.

FIG. 3 is an enlarged view taken along the line 3-3 of FIG. 2.

FIG. 4 is an enlarged view taken along the line 4-4 of FIG. 1.

FIG. 5 is an enlarged view taken along the line 5-5 of FIG. 2.

FIG. 6 is a perspective view of the base or substrate for another flat panel display which includes circuit components mounted on the substrate within the vacuum package.

FIG. 7 is an enlarged view taken along the line 7-7 of FIG. 6.

FIG. 8 is a circuit diagram illustrating the connections between pads on the substrate, and anodes on the substrate of FIG. 7.

FIG. 9 is perspective view showing another embodiment of the invention used in connection with flip chip bonding of a display chip having anode pads and their drive circuits.

### DESCRIPTION OF PREFERRED EMBODIMENTS

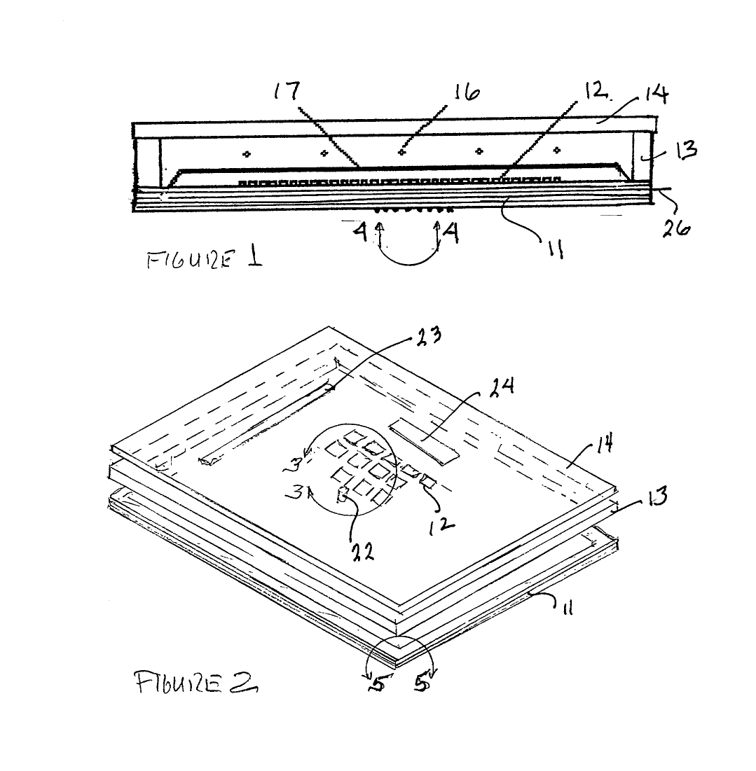

Referring to FIG. 1, the flat panel display includes a base or substrate 11 which supports a pattern of conductive pixels or pads of Ag, Au, Al or C which form the anode pads 12. The anodes are coated with a light-emitting material such as phosphor. The display includes spacer element 13 which forms the walls of the flat panel display. A transparent cover or face such as glass 14 completes the envelope and provides the window for viewing the display area. The substrate, spacer element and transparent cover form an evacuated envelope. Referring again to FIG. 1, the display package includes spaced filaments 16 which are heated to emit electrons which are accelerated towards the anode pads 12 by a grid 17.

The electrons emitted from the cathode/filament are controlled by the grid. When the grid is supplied with a positive voltage it attracts negative electrons, diffuses them and, due to their acceleration, flow through the grid mesh towards the anode. However, when the grid is supplied with a negative voltage, it repels electrons and prevents them from reaching the anode. The anodes are coated with phosphor which emits light when hit by the electrons. Each anode forms a segment, dot or pixel which collectively can form a suitable display. When an anode is supplied with a positive voltage it will attract electrons which have been accelerated through the grid. The phosphor emits light in response to impact by the electrons. Alternatively, when anodes are supplied with a negative voltage they will repel electrons from their phosphorus coating and therefore remain dark. By selecting combinations of illuminated segments the desired digit, character or other display is generated.

Pursuant to the present invention, low temperature co-firing ceramic (LTCC) is used for the substrate and may form the wall 13. By changing the ratio of glass and ceramic in the LTCC, the coefficient of thermal expansion can be matched to the borosilicate or sodium lime glass which forms the display window. The substrate is formed in multiple layers which allows suitable wiring and patterns of wire for connection between the interior and exterior of the display. The laminated multilayers provide a leak-tight substrate since it is subjected to high laminating pressure before firing. Reliable connection between different layers can be made through via holes. The substrate can be processed to form a cavity, bumps, posts or pillars with or without conductive pads at top or bottom of unequal heights because the LTCC gives small shrinkage rates after firing, less than 1%. It allows accurate package size and exact electrode distance when the electrodes are formed on the substrate. The metal pads forming the anodes and other electrical connections form strong adhesion to the ceramic. The pads withstand brazing and welding temperatures during sealing.

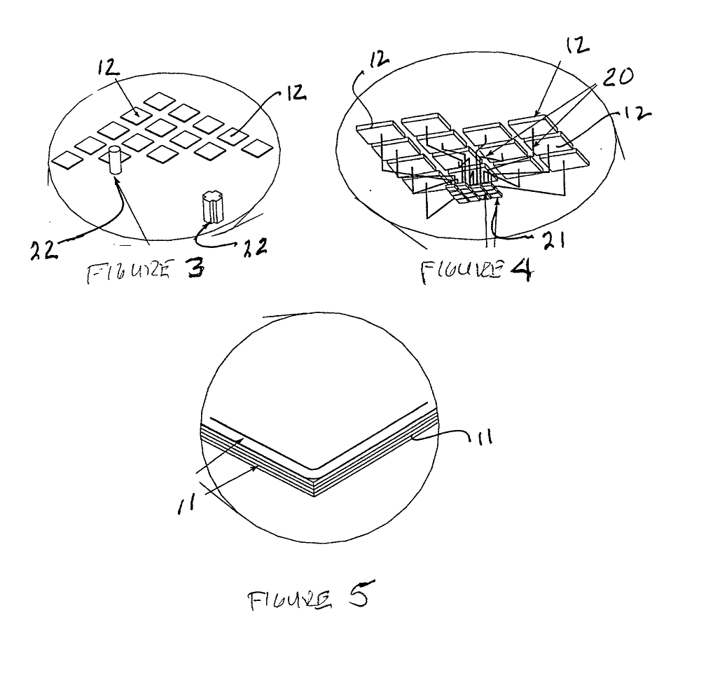

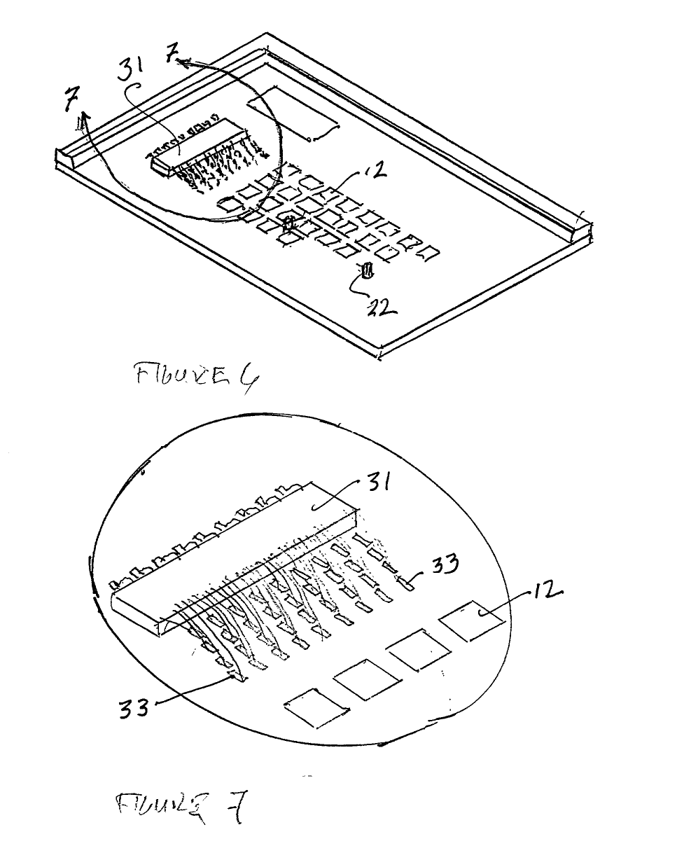

Referring to FIGS. 2 through 5, the multi-layer substrate is illustrated. The anode pads 12 are formed on the substrate 11, and, with particular reference to FIG. 4, electrical connections 20 are made to the pads 12 through the multi-layer substrate 11 to the bonding parts 21 at the bottom of the display. Control voltages and signals can be applied to the anode segments by bonding a control chip to the external bonding pads 21, FIG. 4. Posts 22 may be formed with the substrate and support the extended glass surface when a vacuum is applied to the flat panel display. Thus, the multi-layer substrate permits easy connection through the substrate to the outside with good vacuum characteristics as compared to the prior art use of glass substrate with surface leads. Referring to FIG. 2, there are additionally provided electrode connections 23 and 24 for the grid and filament. The leads or electrical connections extend between layers to the outside as schematically illustrated at 26, FIG. 1. The internal wiring of the LTCC allows the anode pads to be connected vertically through the backside of the substrate, which means the connections spaced around the edges of the display can be drastically reduced. The spacer posts or pillars between substrate and window glass are easily fabricated in the LTCC fabricating process. The electrical circuits including drive components, voltage converters and other necessary components can all be located on the back side of the substrate and thus reduce the system costs and minimize the size of the flat panel display.

The vacuum envelope is completed by using eutectic brazing which allows lower working temperatures and allows heating such as by infrared beam laser beam or electron beam in an vacuum chamber. This provides benefits like less oxidation of delicate anode material, a delicate filament material and other electrodes. Local beam heating dissipates much lower energy consumption than oven or furnace heating. The provision of LTCC allows the formation of metal pads which are applied at higher firing temperatures and form strong metal pad adhesion to the substrate. It allows new metal fixing processes such electron beam or parallel gap resistance welding that is much faster and oxidizing free process than is the conductive frit firing of prior art displays using glass substrates.

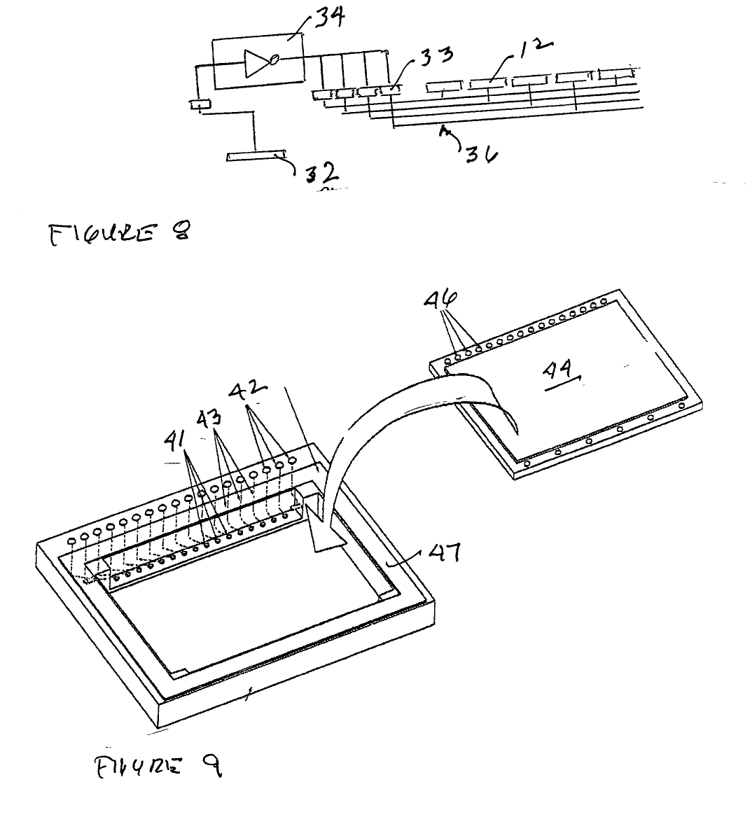

FIGS. 6 and 7 illustrate a flat panel vacuum display package in which some of the control elements such as the anode control chip 31 are mounted within the package or envelope and connected to the exterior bottom of the envelope by external pad 32, FIG. 8, and internally to each of the inputs by metal pads 33. A driver 34 in the chip is connected to the pads 33 which in turn are connected to the anode plates 12 via embedded leads 36, FIG. 8.

The present invention can also be applied for use in a micro display in which silicon based semiconductor chips having anode pads and driving circuits are mounted within the evacuated envelope. Referring to FIG. 9, the substrate provides the wire bonding or bump bonding pads 41 such as gold, silver or copper pads which are connected to the external pads 42 by wiring 43 which extends through the multi-layer ceramic. The microdisplay chip 44 includes pads or bumps 46 which connect to the pads when it is flipped into position. The substrate also provides the spacer function to keep the appropriate distance between the microdisplay face and the window glass. If other pads are necessary, such as the pads for connection to the filament and grid, they can be formed on the substrate within the envelope and connected to external circuits. In FIG. 2, the envelope is formed by the substrate and the transparent window and the intermediate metal ring. In FIG. 9, the substrate is molded to provide the side walls 47. The only sealing step is to seal the window to the substrate via a bonding metal.

Thus, there has been provided an improved vacuum display package in which connections between elements or circuits within the evacuated envelope are connected to exterior circuits by wiring or leads which are embedded in a multilayered ceramic substrate which forms part of the evacuated envelope.

What is claimed is:

1. A flat panel display comprising:
a substrate,
side walls, and
a transparent window secured to said side walls and forming an evacuated envelope characterized in that,
said substrate comprises multi-layer co-fired ceramic material with electrical leads extending between and through said layers for connecting external circuits to internal display elements or circuits.

2. A flat panel display comprising a multilayer ceramic substrate, a transparent window and side walls forming an evacuated envelope, display elements carried by said substrate within said envelope and leads embedded in said ceramic substrate extending between the interior of the evacuated envelope and the exterior of said evacuated envelope to thereby provide electrical connection between devices outside of said envelope and the display elements within the envelope.

3. A flat panel display as in claim 2 in which the display elements include anode pads.

4. A flat panel display as in claim 2 in which the display elements include a semiconductor chip having anode pads and their drive circuits.

5. A flat panel display as in claim 2 in which the display elements include anode pads and associated drive circuits.

6. A flat panel display as in claims 2, 3, 4 or 5 in which the display elements include a cathode filament and a control grid.

7. A flat panel display as in claim 2 in which the substrate is configured to form the side walls.

8. A flat panel display as in claim 2 in which the substrate is configured to form support posts which engage and support the window from the display elements.

9. A flat panel display comprising a multilayer ceramic substrate, a transparent window and side walls forming an evacuated envelope, anode pads supported by said substrate within said envelope and electrical leads embedded in said substrate and extending from the base of said substrate to and connected to said anode pads whereby control circuits can be connected to said anodes.
